(19) United States
(12) Patent Application Publication
(10) Pub. No.: US 2006/0074720 A1
(43) Pub. Date: Apr. 6, 2006

(54) Medical planning agent

(76) Inventors: Alfons Brutting, Waischenfeld (DE); Heinz Prihoda, Heroldsberg (DE); Kai Strasdas, Erlangen (DE)

Correspondence Address: SCHIFF HARDIN, LLP;PATENT DEPARTMENT, 6600 SEARS TOWER, CHICAGO, IL, 60606-6473, US

(21) Appl. No.: 11/231,150

(22) Filed: Sep. 20, 2005

Related U.S. Application Data
(60) Provisional application No. 60/611,613, filed on Sep. 21, 2004.

(30) Foreign Application Priority Data
Sep. 21, 2004 (DE) 10 2004 045 746.8

(51) Int. Cl. G06F 19/00

(52) U.S. Cl. 705/3; 705/2

(57) ABSTRACT

A system and method to plan medical diagnosis and/or therapy procedures is provided. The method includes electronic recording of a patient anamnesis (medical history), electronic recording of a patient finding, automatic generation of a keyword list dependent on the patient anamnesis and the patient finding by access to a keyword databank, automatic generation of diagnosis and/or therapy measure list dependent on keywords of the keyword list under access to a medical databank, automatic assessment of diagnosis and/or therapy measures of the diagnosis and/or therapy measure list under access to a case databank, automatic temporal pre-allocation of resources necessary for the implementation of diagnosis and/or therapy measures, dependent on a result of the assessment of the diagnosis and/or therapy measures under access to a resource databank, automatic generation of at least one diagnosis and/or therapy procedure dependent on the pre-allocation of resources, automatic generation of an electronic checklist with diagnosis and/or therapy measures and temporal pre-allocation of resources necessary for implementation of these diagnosis and/or therapy measures. The method allows flexible planning adapted to the current availability of resources and, via the immediate enlistment of expertise, ensures a consistent quality of the diagnosis and/or therapy planning.

### CROSS-REFERENCE TO RELATED APPLICATION

This application claims the benefit of U.S. Provisional Patent Application Ser. No. 60/611,613, filed Sep. 21, 2004.

### BACKGROUND OF THE INVENTION

1. Field of the Invention

The present invention concerns a method and a system for planning of diagnosis and/or therapy procedures. Diagnostic procedures include a plurality of individual diagnostic measures. A diagnostic procedure is a temporal sequence of diagnostic measures, whereby the sequence can influence the efficiency and quality of the diagnostic procedure.

2. Description of the Related Art

Diagnosis and/or therapy procedures are typically planned by medical specialists. The planning of a diagnostic procedure on the one hand comprises the selection of the diagnostic measures necessary for a diagnosis. It typically ensues via a doctor or medic who examines the patient to be diagnosed. The doctor or physician additionally records the anamnesis (or medical history) of the patient, i.e. the history of the illness according to the statements of the patient, and implements a first finding that is based on immediately implementable diagnostic measures such as optical pupil reflex test, auscultation of heart sounds, pulse measurement, blood pressure measurement, sampling of the patient, etc. Using the anamnesis and immediate finding, the physician or doctor decides which diagnostic measures should be implemented and in which temporal sequence this should happen. For example, a referring doctor sends a patient to a radiologist. The radiologist checks the previous examination using the illness history (anamnesis) and symptoms (finding) and selects a suitable further examination method.

This first diagnosis and/or therapy planning is recorded in the further clinical management and considered for the planning of the further operational procedures. The further planning ensues, for example, via a department management or head nurse of radiology who arranges a final plan for the operational procedure of the respective diagnostically operating department or radiologist under consideration of further input parameters such as vacation times, coworker competency, availability of diagnostic devices and typical occupancy duration of such devices. This working plan contains all diagnosis and/or therapy procedures authorized by the doctor or physician.

The planning by a department management or a head nurse is unavoidably subject to subjective criteria and can thereby lead to working plans of different efficiency given various planners. Moreover, the planning individual cannot have knowledge of all influencing variables significant for the planning. Thus, for example, the current occupancy or operational readiness of diagnostic devices, the current status of diagnostic measures already in operation or a consideration of current additional diagnosis and/or therapy procedures, for example the acute emergency patients, cannot all be simultaneously comprehended. The subjective planning can therefore cause an unequal quality level, erroneous diagnosis standards, long wait times, poor resource utilization culminating in wrong medical decisions.

For example, a precautionary examination of a healthy patient at the CT (Computed Tomography) apparatus can be shifted before the examination of ailing patients that must be operated on the next day. Due to a possible emergency admission of an acute patient, it can then occur that the examination of a patient to be operated on on this day cannot be implemented as originally planned. Thus, all plans and scheduling of the following days would be disarranged. Such complex scenarios are, however difficult to sufficiently consider and survey in order to be able to prevent the described problem.

### SUMMARY OF THE INVENTION

The present invention provides the possibility for planning complex diagnosis and/or therapy procedures that simultaneously ensure high efficiency and a consistently high quality.

The invention provides a method to plan diagnosis and/or therapy procedures, including: electronic recording of a patient anamnesis, electronic recording of a patient finding, automatic generation of a keyword list dependent on the patient anamnesis and the patient finding under access to a keyword databank, automatic generation of diagnosis and/or therapy measure list dependent on keywords of the keyword list under access to a medical databank, automatic assessment of diagnosis and/or therapy measures of the diagnosis and/or therapy measure list under access to a case databank, automatic temporal pre-allocation of resources necessary for the implementation of diagnosis and/or therapy measures, dependent on a result of the assessment of the diagnosis and/or therapy measures under access to a resource databank, automatic generation of at least one diagnosis and/or therapy procedure dependent on the pre-allocation of resources, automatic generation of an electronic checklist with diagnosis and/or therapy measures and temporal pre-allocation of resources necessary for implementation of these diagnosis and/or therapy measures.

The invention also provides a system to plan diagnosis and/or therapy procedures, including: a keyword wizard via which a keyword list can be automatically generated dependent on the electronic patient anamnesis and an electronic patient finding under access to a keyword databank; a checklist agent via which a diagnosis and/or therapy measure list can be automatically generated dependent on keywords of the keyword list under access to a medical databank; a data miner via which diagnosis and/or therapy measures of the diagnosis and/or therapy measure list can be automatically assessed under access to a case databank; a resource planner via which the resources necessary for the implementation of diagnosis and/or therapy measures can be automatically temporally pre-allocated dependent on a result of the assessment of the diagnosis and/or therapy measures under access to a resource databank, via which at least one diagnosis and/or therapy procedure can be automatically generated dependent on the pre-allocation of resources, and via which an electronic checklist can be automatically generated with diagnosis and/or therapy measures and temporal pre-allocations of resources necessary for the implementation of these diagnosis and/or therapy measures.

### BRIEF DESCRIPTION OF THE DRAWINGS

FIG. 1 is a schematic sequence of system components according to the principles of the invention, and

FIG. 2 is a schematic sequence of method steps according to the invention.

### DETAILED DESCRIPTION OF THE PREFERRED EMBODIMENTS

The present invention is based on a central idea to electronically record and to automatically analyze the patient anamnesis that is already acquired in the first preliminary diagnosis of the patient by the doctor or physician, and thereby to automatically incorporate the current availability or, respectively, utilization of personnel and other resources. The automatic analysis includes the generation of a keyword list dependent on the anamnesis and the finding; the generation of a diagnostic measure list; the automatic assessment of diagnostic measures of the diagnostic measure list; the automatic temporal pre-allocation of resources necessary to implement diagnostic measures dependent on the result of the assessment of the diagnostic measures; the generation of at least one diagnostic procedure dependent on the pre-allocation of the resources; and the generation of an electronic checklist that contains diagnostic measures and corresponding temporal pre-allocations of resources. It is thereby enabled to automatically plan diagnosis and/or therapy procedures that connect individual diagnostic measures into a schedule and to offer a supervision possibility in the form of the checklist, using which the status of the execution of a respective diagnostic procedure can be supervised.

This core idea of the invention can be realized via a system that comprises a keyword wizard that can generate keyword lists using the anamnesis and the finding, a checklist agent via which diagnostic measures can be derived from the keyword list, a data miner via which diagnostic measures can be assessed under consideration of empirical information, and a resource planner via which resources required for implementation of the diagnostic measures an be automatically temporally pre-allocated, and via which at least one diagnostic procedure can thereby be generated that can be indicated in an electronic checklist.

The system includes a system component referred to as a “keyword wizard” that accesses all patent data of the accessible electronic patient record, in particular the anamnesis and the finding, and additionally accesses a medical keyword databank.

The system includes a system component referred to as a “checklist agent” that accesses the keyword list, the stored expertise and other data in the clinical information system, including for example operational plans, employee competency, house occupancy or allocation of diagnostic devices, etc. Among other things, a query is submitted to the stored expertise as to which diagnostic measure is connected with which expenditure and what competency is necessary for this, which combination of diagnostic measures experientially lead to good results, or which therapy steps would be derived from which diagnosis results.

The system includes a system component referred to as a “data miner” which accesses stored illness and treatment histories of a plurality of patients. The access ensues with regard to an evaluation of the stored data in view of the evaluation of the quality or the chance of success of a proposed diagnostic procedure.

The system also includes a system component referred to as a “resource planner” which accesses the occupancy or allocation plans of the diagnostic devices, for example the imaging devices, and of inventories, for example of laboratory chemicals.

By utilizing the features of preferred embodiments of the invention, the advantage results that a user, who may be for example a clinical doctor, can select a particularly suitable diagnostic method even during the initial patient interview or the visit that can be implemented quickly and at a cost savings. Another advantage is that the assigned examination department, for example the radiology department, may have its operational procedure more efficiently planned and is not stressed by the execution of comparatively fewer suitable examinations.

An advantage of the invention in particular results from the present method by checking the respective current actual existing utilization or, respectively, availability of personnel and other resources at every moment. This enables a more exact, error-free planning and helps to prevent wait times and idle times. Moreover, unforeseeable and therefore unplannable circumstances, such as the sudden hospitalization of acute emergency patients, can thereby be flexibly accommodated without having to disrupt complete operational plans for the aftermath. The optimal temporal utilization is connected with higher efficiency and lower costs.

Not last, the dynamic generation of the checklists frees up the available storage space that would otherwise be necessary for the storage and archiving of all checklists and diagnosis and/or therapy procedures.

A further advantage is that the use of empirical and expert knowledge by the data miner can ensure a consistent quality of the proposals for diagnostic measures and therewith can protect the standard of the diagnosis quality.

The dynamic generation of the checklists ensuing, so to speak, in real time moreover enables it, in addition to the filing and monitoring of the completely planned procedures, to also support the doctor who must come to decisions for planning of the steps. In the checklist, all details (thus the relevant output data of the individual wizards/agents) are clearly represented and combined, such that the doctor sees at a glance all possibilities for the planning, and namely including temporal and qualitative consequences for the complete planned treatment. On this basis, the doctor can come to substantiated decisions about which measures should actually be implemented or which measures should be implemented first.

The dynamic use of the checklists is in particular to be used in an advantageous manner as an iterative process, meaning that after each individual planned or concluded measure the complete chain is gone through again in order to plan the next measure or measures on the basis of the information added to the checklist.

The invention has so far been primarily described with regard to the planning of diagnostic measures. The following description also predominantly concerns diagnostic measures. However, it is applicable in the same manner to the planning of therapy measures.

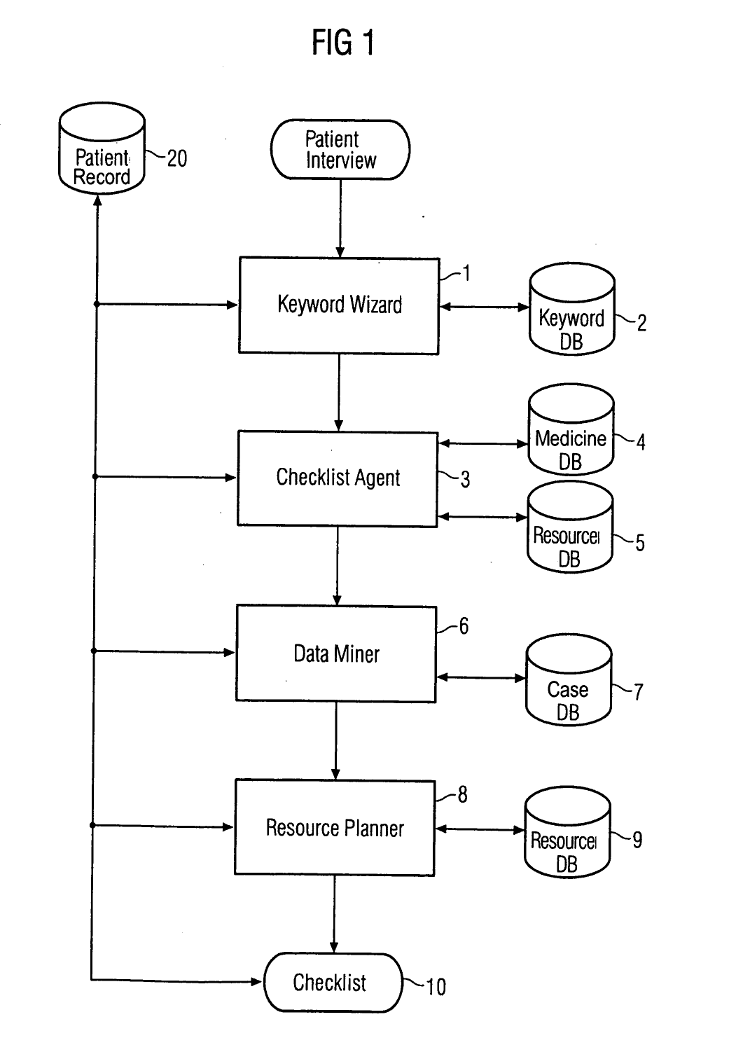

With reference to the drawings, in FIG. 1, a schematic sequence of the system components for the planning of diagnosis and/or therapy procedures is shown. In a first step, a doctor or physician conducts a conversation with a patient (also referred to as a patient interview) in order to acquire the patient anamnesis or medical history and to arrive at a first patient finding. For example, a patient can have been referred from a referring general practitioner to a radiologist who now acquires the anamnesis and implements a finding. A possible anamnesis could be as follows:

“For year fits of dizziness, headaches and vomiting have become more common. In the last three weeks, vomiting more than three times per day, approximately 3 hours after meal times. In this time weight loss of approximately 7 kg. No problems with nutrition previously known. Neurological examination 6 months ago without pathological findings.”

An associated finding which the radiologist can immediately record could be as follows:

“Skin pale, throat and thorax without finding, lungs without finding, heart sounds pure, quiet. Pulse 65, blood pressure 160/90, liver palpable 1 qf under costal arch, rest of abdomen without pathological finding. No pressure pain, no edema.”

Anamnesis and finding are recorded by the radiologist in an electronic patient record 20.

The electronic patient record 20 for the patient goes to the keyword wizard 1 that has additional access to a keyword databank 2. The keyword wizard 1 analyzes the electronic patient record 20, for example via comparison of individual words with keywords that are stored in the keyword databank 2. A keyword list is obtained as the result of this analysis that the keyword wizard 1 reproduces as an output signal.

The keyword list is thereupon analyzed by the checklist agent in order to determine possible diagnostic measures that present themselves from the anamnesis, the finding and, if applicable, the other content of the patient record 20. For this purpose, the checklist agent 3 has access to a medical databank 4 that can be searched through using the keywords, whereby specific combinations and sequences of keywords can also be considered. Furthermore, the checklist agent 3 also has access to a resource databank 5 that allows it to determine which resources are actually accessible. Within the scope of the term resources as understood with regard to the present invention are diagnostic devices as well as consumable agents, as well as the availability and professional competence of medical specialists.

For example, the following keyword list can have resulted from the preceding exemplarily reproduced anamnesis and finding via the analysis of the keyword wizard 1:
1. Dizziness, vomiting
2. Thorax, heart, skull, abdomen.

Using these keywords, the checklist agent 3 can, for example, determine the following possible diagnostic measures, whereby the list of these measures can contain a plurality of alternatives for selection that can by all means be redundant with regard to a specific diagnosis.

“Clarification cerebellum tumor, clarification gastric-CA (gastric Carbonic Anhydrase), clarification kidney-CA; laboratory, EKG (electrocardiogram), CT skull (computed tomography), x-ray thorax in two planes, gastroscopy, sonography upper abdomen, MR skull (Magnetic Resonance), MR thorax, MR upper abdomen”

Via access to the resource databank 5, the checklist agent 3 excludes such diagnostic measures for which the necessary resources are lacking. For example, it is possible that no MR (magnetic resonance) device is available; MR exposures are therefore stricken from the list of possible diagnostic measures. The identified possible diagnostic measures are characterized overall in that they serve for the diagnostic clarification of the findings that are contained in the keyword lists. The diagnostic measures list is provided by the checklist agent 3 as an output signal.

The diagnostic measure list is subsequently subjected to an assessment by the data miner 6. For this purpose, the data miner 6 combines the possible findings contained in the keyword list with the respective possible diagnostic measures suitable for clarification and compares them with empirical information that, for example, can have been created from the evaluation of similar cases in the past. For this purpose, the data miner 6 has access to a case databank 7 from which it can determine the corresponding cases, for example via comparison of anamnesis and finding as well as, possibly, patient age and gender and further information from the keyword list. Under access to the case databank 7, the data miner 6 can thus effect an assessment of the possible diagnostic measures or of diagnostic procedures that result as a sequence of possible diagnostic measures. Assessment criteria can thereby be the effectiveness or the relevance for the respective case, moreover the finding quality, cost, duration of the measures or procedures, wait times between individual measures, the statistical significance of the empirical information, for example, dependent on of the number of the cases in the case databank 7, etc.

As a result, the data miner 6 combines a diagnosis procedure made up of one or more individual diagnostic measures with the respective possible finding, if applicable in the optimal sequence for the implementation of these measures. Since in particular more complex anamneses and findings normally allow a plurality of possible diagnoses as alternatives or supplements, the data miner 6 will normally combine multiple diagnostic procedures for alternative clarification into the same diagnosis as well as for clarification of various diagnoses. For every possible diagnostic procedure, a statement of the necessary medical specialist together with the corresponding qualification is specified and a statement of the necessary diagnostic device together with the respective degree of suitability for the respective diagnostic measure is specified. Moreover, for every possible diagnostic procedure, an evaluation is specified that, for example, considers the entire diagnostic procedure duration, the examination duration on the diagnostic devices for individual diagnostic measures, the personnel expenditure, the wait times between individual diagnostic measures, the probable success of the respective diagnostic procedure based on experience, etc. The proposed diagnostic procedures together with additional information and assessment are provided by the data miner 6 as an output signal.

The resource planner 8 compares each proposed diagnostic procedure with regard to the required resources with specifications for the availability of personnel, diagnostic devices as well as consumables or laboratory times under access to the resource databank 9. On the one hand, the resource databank 9 lists all resources available in a working environment; on the other hand it contains information that enables the determination and processing of an allocation plan for the resources.

The resource planner 8 effects a pre-allocation of resources in the resource databank 9 for every possible diagnostic procedure, such that the temporal sequence of the individual diagnostic measures contained therein can be specified for every possible diagnostic procedure. As a consequence if the pre-allocation of the resources, these are tentatively prohibited from pre-allocation from another side, such that the determined possible temporal sequences of the diagnostic procedures are respectively generated dynamically and can be realistically be adhered to. A prioritization of a plurality of users can thereby be provided insofar as, for example, diagnostic procedures for acute emergency patients enable the pre-allocation of resources with higher priority and, for this purpose, can, for example, temporally shift the pre-allocations for diagnostic procedures of lower priority or displace the use of other resources. As a result, the resource planner 8 generates as an output signal one or more diagnostic procedures with a realistically observable sequence of the individual diagnostic measures.

These realistically pre-planned diagnostic procedures are displayed to a user together with the assessment of the data miner 6, who can thereupon select one or more diagnostic procedures. Since the resources have been tentatively allocated as far as the final selection of a diagnostic procedure, a time limit can be provided in which a user has to make his selection. After expiration of this time limit, for example, the validity of the proposed temporal procedures can expire.

For example, the data miner 6 could determine that although a proposed diagnostic procedure would be logically applied and executable in the shortest period of time, it would still not be applied while a different diagnostic procedure would in fact last 20% longer, however in return it has already been applied successfully multiple times. Such an alternative would have to be decided by a user in the event that the system would have no unambiguous instructions for consideration.

After the selection of one or more diagnostic procedures by a user, for example the radiologist assigned with the case, the preliminary allocation of the resources in the resource databank 9 is ultimately fixed; the preliminary pre-allocation in connection with the unselected diagnostic procedures is cancelled. The resource planner 8 then generates a checklist 10 based on the selected diagnostic procedures. The checklist 10 is deposited in the patient record 20 and contains information for the temporal sequence of the individual diagnostic measures as well as for the execution status and, if applicable, for individual results of the respective measure.

For example, the following diagnostic procedures from which the radiologist can select can alternatively be proposed using the preceding described anamnesis and finding:

“Alternative 1: clarification cerebellum tumor

laboratory immediate checkbox

EKG today, 14:45 checkbox

CT skull tomorrow, 9:30 checkbox

Alternative 2: clarification stomach-CA

laboratory immediate checkbox (small box?)

The checklist 10 is subsequently available to every user of the patient record 20. Members of the medical team that are responsible for individual diagnostic measures of the checklist 10 can input their execution status, for example via activation of checkboxes; additionally they can store results of these diagnostic measures in the checklist or at another location in the patient record 20. Other participants of the medical team can thus view the status of preceding diagnostic measures in order to be able to plan the execution of the diagnostic measures to be implemented by them or to be able to plan possible therapy measures or to derive possible therapy measures. Moreover, possible delays in the diagnostic procedure can be seen using the checklist that can likewise be considered for planning of the further routine measures.

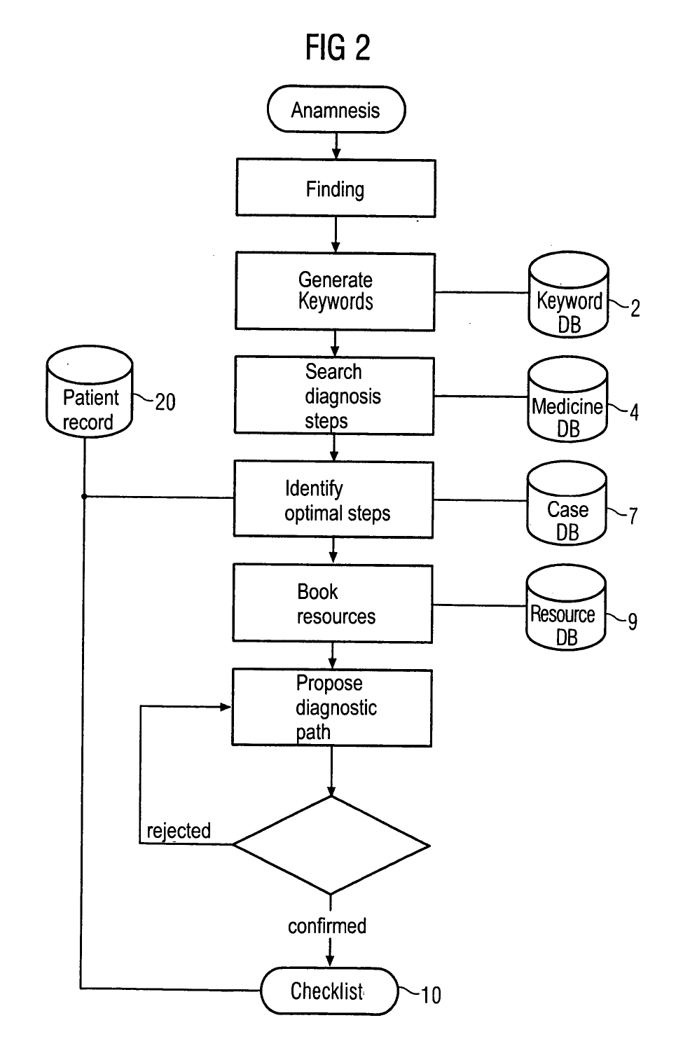

The individual steps of the automatic diagnosis and/or therapy procedure planning is generally indicated in FIG. 2 according to a type of flow diagram. In a first step, the patient anamnesis is acquired by the doctor or physician, in the present example by a radiologist. In the following step, a first finding is implemented by the radiologist. Anamnesis and finding are recorded electronically.

In a following step, anamnesis and finding are analyzed and a keyword list is generated under access to a keyword databank 2. On the one hand, the keyword list contains keywords that result from anamnesis and finding, for example: dizziness, vomiting, weight loss. On the other hand, it contains keywords that could result in possible diagnoses in connection with anamneses and finding, for example: cerebellum tumor, gastric-CA, kidney-CA.

In a following step, using the keyword list and under access to a medical databank 4, it is established which diagnostic measures can be drawn upon for clarification of the possible diagnoses, for example; laboratory, EKG, CT, x-ray, gastroscopy, sonography, MR. For example, a conventional key data search engine can be used in connection with the creation and use of the keyword list.

In a further step, an assessment ensues of the possible diagnostic measures or, respectively, possible diagnostic procedures that are comprised of individual diagnostic measures. For assessment, a case databank 7 is accessed that contains empirical data from the evaluation of earlier cases. Among other things, expertise can thereby be accessed for which conventional expert systems can be used. If applicable, neural nets can also be accessed in this context.

In a subsequently step, possible diagnostic procedures are temporally planned under access to a resource databank 9, whereby it is considered which resources are actually available and how the available resources are allocated out. For example, it can be established that an MR device is not available, such that diagnostic procedures using MR examinations are not realizable. For the available resources, temporal pre-allocations are effected using which a temporal procedure plan can be arranged for respective diagnostic procedure. For the planning of the resources, a conventional workflow engine for process planning can be accessed. The resource planning thereby also considers the parallel resource planning by other users who have influence on the temporal availability of the resources. The preliminary pre-allocation of resources therefore results dynamically from the respective current overall situation.

In a further step, the possible and temporally pre-planned diagnostic procedures are proposed to a user for selection under declaration of information regarding their assessment. If the user dismisses a possible diagnostic procedure, if applicable a further proposal is made. If the user approves a diagnostic procedure that contains a temporal diagnostic procedure plan, in a further step a checklist 10 is generated that contains a temporal diagnostic procedure plan that lists the individual diagnostic measures together with respective date and execution status. The checklist 10 is placed in the patient record 20.

It can additionally be provided that all used databanks and, if applicable, expert systems or neural nets are updated as a result of the diagnosis planning as well as execution of the diagnostic measures. The record can thereby be incorporated into the databank as expertise with the respectively current diagnostic procedure, for example with regard to necessary competency, temporal and personnel effort, resulting diagnostic wrong decisions and diagnosis quality, in order to be available for future diagnostic procedure planning. In particular information about temporal expenditures are thus maintained in the resource databank 9; information about temporal expenditure and diagnosis quality are maintained in the case databank 7.

Thus, an embodiment of the invention provides a method to plan diagnosis and/or therapy procedures, comprising the steps:

a) electronic recording of a patient anamnesis,

b) electronic recording of a patient finding,

c) automatic generation of a keyword list dependent on the patient anamnesis and the patient finding under access to a keyword databank (2),

d) automatic generation of diagnosis and/or therapy measure list dependent on keywords of the keyword list under access to a medical databank (4),

e) automatic assessment of diagnosis and/or therapy measures of the diagnosis and/or therapy measure list under access to a case databank (7),

f) automatic temporal pre-allocation of resources necessary for the implementation of diagnosis and/or therapy measures, dependent on a result of the assessment of the diagnosis and/or therapy measures under access to a resource databank (9),

g) automatic generation of at least one diagnosis and/or therapy procedure dependent on the pre-allocation of resources,

h) automatic generation of an electronic checklist (10) with diagnosis and/or therapy measures and temporal pre-allocation of resources necessary for implementation of these diagnosis and/or therapy measures.

An embodiment of the invention further provides a method, whereby in a further step the checklist (10) is stored in an electronic patient record (20).

According to aspects of the invention a method is provided whereby a plurality of possible diagnosis and/or therapy procedures are proposed, and whereby the checklist (10) is generated dependent on the selection of one of the plurality of diagnosis and/or therapy procedures by a user, for example a physician.

The invention of one embodiment further provides a method, whereby an automatic evaluation of the plurality of diagnosis and/or therapy procedures ensues and the user is shown (for example using one or more of the criteria) diagnosis and/or therapy procedure duration, resource allocation duration, personnel expenditure, compatibility for the patient, wait time between diagnosis and/or therapy steps, chance of success and costs of a diagnosis and/or therapy measure.

The invention of another embodiment may also provide a system to plan diagnosis and/or therapy procedures, comprising: a keyword wizard (1) via which a keyword list can be automatically generated dependent on the electronic patient anamnesis and an electronic patient finding under access to a keyword databank (2); a checklist agent (3) via which a diagnosis and/or therapy measure list can be automatically generated dependent on keywords of the keyword list under access to a medical databank (4); a data miner (6) via which diagnosis and/or therapy measures of the diagnosis and/or therapy measure list can be automatically assessed under access to a case databank (7); a resource planner (8) via which the resources necessary for the implementation of diagnosis and/or therapy measures can be automatically temporally pre-allocated dependent on a result of the assessment of the diagnosis and/or therapy measures under access to a resource databank (9), via which at least one diagnosis and/or therapy procedure can be automatically generated dependent on the pre-allocation of resources, and via which an electronic checklist (10) can be automatically generated with diagnosis and/or therapy measures and temporal pre-allocations of resources necessary for the implementation of these diagnosis and/or therapy measures.

The preferred embodiment may further provide a system, whereby the checklist (10) can be stored in an electronic patient record (20) by the resource planner (8).

In yet another preferred embodiment, the invention also provides a system, whereby a plurality of possible diagnosis and/or therapy procedures can be proposed by the resource planner (8); whereby an input possibility is provided for the selection by a user, for example a physician, of one of the plurality of diagnosis and/or therapy procedures; and whereby the checklist (10) can be generated dependent on the selection of a diagnosis and/or therapy procedure.

The invention may also a method, whereby an automatic evaluation of the plurality of diagnosis and/or therapy procedures can be effected and displayed to the user via the resource planner (8), for example using one or more of the criteria: diagnosis and/or therapy procedure duration, resource allocation duration, personnel expenditure, compatibility for the patient, wait time between diagnosis and/or therapy steps, chance of success and costs of a diagnosis and/or therapy measure.

Thus, there has been shown and described a medical planning agent system and method to plan diagnosis and/or therapy procedures that includes generating an electronic recording of a patient anamnesis, generating an electronic recording of a patient finding, automatically generating a keyword list dependent on the patient anamnesis and the patient finding via access to a keyword databank, automatically generating a diagnosis and/or therapy measure list dependent on keywords of the keyword list under access to a medical databank, automatically assessing the diagnosis and/or therapy measures of the diagnosis and/or therapy measure list via access to a case databank, automatically providing a temporal pre-allocation of resources necessary for the implementation of diagnosis and/or therapy measures depending on the result of the assessment of the diagnosis and/or therapy measures under access to a resource databank, automatically generating at least one diagnosis and/or therapy procedure dependent on the pre-allocation of resources, and automatically generating an electronic checklist with diagnosis and/or therapy measures and providing a temporal pre-allocation of resources necessary for implementation of these diagnosis and/or therapy measures.

The method and system allows a planning flexibly adapted to the respective currently determined availability of resources and, via the immediate enlistment of expertise, ensures a consistent quality of the diagnosis and/or therapy planning.

Although other modifications and changes may be suggested by those skilled in the art, it is the intention of the inventors to embody within the patent warranted hereon all changes and modifications as reasonably and properly come within the scope of their contribution to the art.

We claim:

1. A method for planning diagnosis and/or therapy procedures, comprising the steps:
electronically recording a patient anamnesis;
electronically recording a patient finding;
automatically generating a keyword list dependent on the patient anamnesis and the patient finding by accessing a keyword databank;
automatically generating a diagnosis and/or therapy measure list dependent on keywords of the keyword list by accessing a medical databank;
automatically assessing diagnosis and/or therapy measures of the diagnosis and/or therapy measure list by accessing a case databank;
automatically providing a temporal pre-allocation of resources necessary for implementation of the diagnosis and/or therapy measures depending on a result of the step of automatically assessing step by accessing a resource databank;
automatically generating at least one diagnosis and/or therapy procedure dependent on the temporal pre-allocation of resources; and
automatically generating an electronic checklist with diagnosis and/or therapy measures and the temporal pre-allocation of resources necessary for implementation of these diagnosis and/or therapy measures.

2. A method according to claim 1, further comprising the step of: storing the electronic checklist in an electronic patient record.

3. A method according to claim 1, further comprising the step of:
proposing a plurality of possible diagnosis and/or therapy procedures;
receiving a selection of one of the possible diagnosis and/or therapy procedures from a user; and
generating the electronic checklist dependent on the selection of one of the possible diagnosis and/or therapy procedures.
automatically evaluating the plurality of possible diagnosis and/or therapy procedures;
showing a user at least one of the following data: diagnosis and/or therapy procedure duration, resource allocation duration, personnel expenditure, compatibility for a patient, wait time between diagnosis and/or therapy steps, chance of success, and costs of a diagnosis and/or therapy measure.

5. A system for planning diagnosis and/or therapy procedures, comprising:
a keyword databank;
a keyword wizard connected to said keyword databank and connected to receive an electronic patient anamnesis and an electronic patient finding and operable to automatically generate a keyword list dependent on the electronic patient anamnesis and the electronic patient finding by accessing said keyword databank;
a medical databank;
a checklist agent connected to said medical databank and connected to receive said keyword list from said keyword wizard and operable to automatically generate a diagnosis and/or therapy measure list dependent on keywords of said keyword list by accessing said medical databank;
a case databank;
a data miner connected to said case databank and connected to receive said diagnosis and/or therapy measure list and operable to automatically assess diagnosis and/or therapy measures of said diagnosis and/or therapy measure list by accessing said case databank;
a resource databank;
a resource planner connected to said resource databank and connected to receive said diagnosis and/or therapy measures from said data miner and operable to automatically temporally pre-allocate resources necessary for implementation of said diagnosis and/or therapy measures depending on a result of an assessment of said diagnosis and/or therapy measures by accessing said resource databank, at least one diagnosis and/or therapy procedure being automatically generated dependent on said temporal pre-allocation of resources, and an electronic checklist being automatically generated with said diagnosis and/or therapy measures and said temporal pre-allocation of resources necessary for implementation of said diagnosis and/or therapy measures.

6. A system according to claim 5, wherein said resource planner is operable to store said electronic checklist in an electronic patient record.

7. A system according to claim 5, wherein said resource planner is operable to propose a plurality of possible diagnosis and/or therapy procedures; and further comprising:
an input for receiving a selection by a user of one of said plurality of diagnosis and/or therapy procedures, the checklist being generated dependent on the selection of the diagnosis and/or therapy procedure.

8. A method according to claim 7, wherein said resource planner is operable to automatically evaluate the plurality of diagnosis and/or therapy procedures and display to the user at least one of the following criteria: diagnosis and/or therapy procedure duration, resource allocation duration, personnel expenditure, compatibility for the patient, wait time between diagnosis and/or therapy steps, chance of success, and costs of a diagnosis and/or therapy measure.
